(19) United States
(12) Patent Application Publication
(10) Pub. No.: US 2007/0153494 A1
(43) Pub. Date: Jul. 5, 2007

(54) Emergency luminaire

(75) Inventor: Hua-Chung Huang, Banciao City (TW)

Correspondence Address: TROXELL LAW OFFICE PLLC, SUITE 1404, 5205 LEESBURG PIKE, FALLS CHURCH, VA, 22041, US

(73) Assignee: HI-LUX Technology Company Limited

(21) Appl. No.: 11/526,155

(22) Filed: Sep. 25, 2006

(30) Foreign Application Priority Data
Dec. 27, 2005 (TW) 094222717

(51) Int. Cl. F21V 25/00; F21L 4/08; H01R 33/00

(52) U.S. Cl. 362/20; 362/183; 362/95; 362/147; 362/652

(57) ABSTRACT

An emergency luminaire comprises a lower housing, an upper frame and a lighting apparatus. The lower housing has a charging socket mounted therein. The upper frame is correspondingly detachably attached to the lower housing. The lower housing can be coupled with a switch box, which is previously embedded in an indoor location. The lighting apparatus has a charging plug in the backside corresponding to the charging socket, which is electrically connected to the commercial electric power. Next, the lighting apparatus is inserted into the lower housing so as to allow a battery mounted inside the lighting apparatus to store the commercial electric power. As a result, when the commercial electric power is disconnected suddenly, the battery can supply the electric power stored therein for illumination, and the lighting apparatus can be detached from the lower housing for providing portable illumination for user.

### FIELD OF THE INVENTION

The present invention relates to an emergency luminaire applicable for various locations such as dwelling houses, office buildings, factories, and so forth.

### BACKGROUND OF THE INVENTION

There are many tall buildings and great mansions around the city since it is hard to acquire spaces in the city. The tall building can raise the utilization rate of land, but great mishap may be caused when natural or man-made disaster such as earthquake or fire accident occurs.

Moreover, the disconnection of electric power always accompanies the occurrence of disaster. If the disaster occurs at night, it will be more difficult to escape. As a result, the arrangement of emergency luminaire is singularly important. Referring to FIG. 6, a conventional common emergency luminaire A has a base A1. Two lamps A2 are pivotally attached to the top of the base A. Once the electric power is cut off, the lamps A2 can be turned on automatically by the control of the battery and the circuit mounted therein so as to help determine the escape direction.

The above-mentioned conventional emergency luminaire achieves the purpose of illumination, but it produces focused light beams, which only illuminate the area right before the lamps without providing surrounding regions with sufficient illumination. In addition, although the lamps, which are pivotally attached to the base, are pivotally rotatable, they are too heavy and huge to carry easily when the sudden disaster occurs.

In view of the foregoing description, the motive of the present invention is to provide the general public with an emergency luminaire, which is easily detachably attachable to a location and makes this location beautiful, for supplying immovable or portable illumination for user when an emergency condition occurs.

### SUMMARY OF THE INVENTION

It is a primary object of the present invention to provide an emergency luminaire able to supply immediate illumination when an emergency condition occurs.

It is another object of the present invention to provide an easily portable emergency luminaire able to supply portable illumination.

It is a further object of the present invention to provide an emergency luminaire, wherein the high-tech light-emitting diode is utilized as a light source to not only reduce the size of the emergency luminaire and save the energy but also beautify the environment.

In order to achieve the above-mentioned objects, an emergency luminaire of the present invention is comprised of a lower housing, an upper frame and a lighting apparatus. The lower housing has a charging socket mounted therein. The upper frame is correspondingly detachably attached to the lower housing. The lower housing can be coupled with a switch box, which is previously embedded in an indoor location. The lighting apparatus has a charging plug in the backside corresponding to the charging socket, which is electrically connected to the commercial electric power. Next, the lighting apparatus is inserted into the lower housing so as to allow a battery mounted inside the lighting apparatus to store the commercial electric power. As a result, when the commercial electric power is disconnected suddenly, the battery can supply the electric power stored therein for illumination, and the lighting apparatus can be detached from the lower housing for providing portable illumination for user.

The aforementioned objects and advantages of the present invention will be readily clarified in the description of the preferred embodiments and the enclosed drawings of the present invention.

### BRIEF DESCRIPTION OF THE DRAWINGS

FIG. 1 is an elevational diagram showing a preferred embodiment of the present invention.

FIG. 2 is an exploded diagram showing the preferred embodiment of the present invention.

FIG. 3 is a cross-sectional view taken along line AA′ of FIG. 2.

FIG. 4 is a schematic diagram showing a usage status of the preferred embodiment of the present invention.

FIG. 5 is a schematic diagram showing another usage status of the preferred embodiment of the present invention.

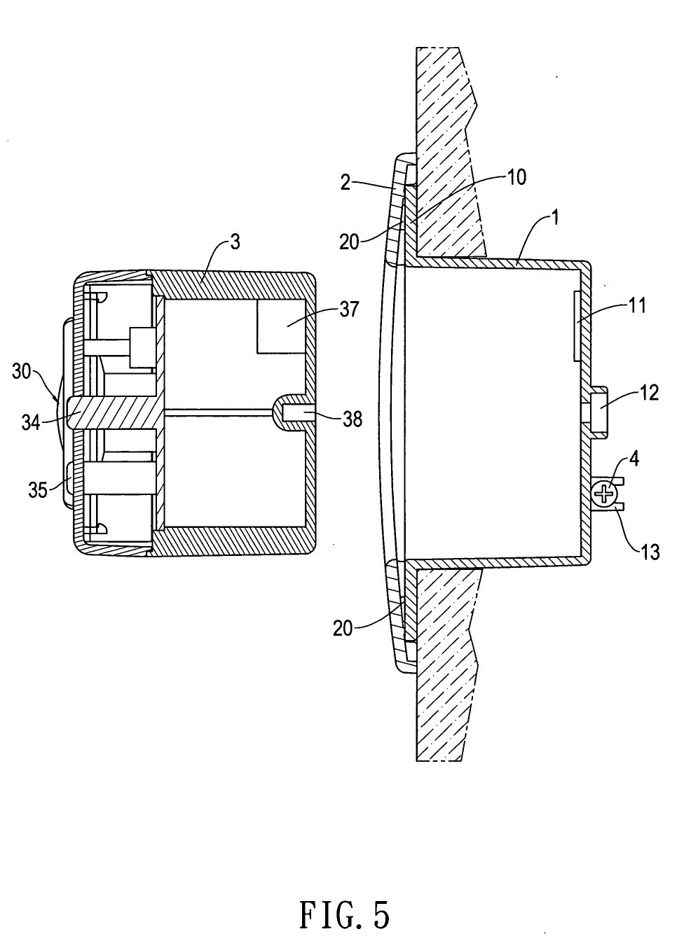

FIG. 6 is an elevational diagram showing a conventional emergency luminaire.

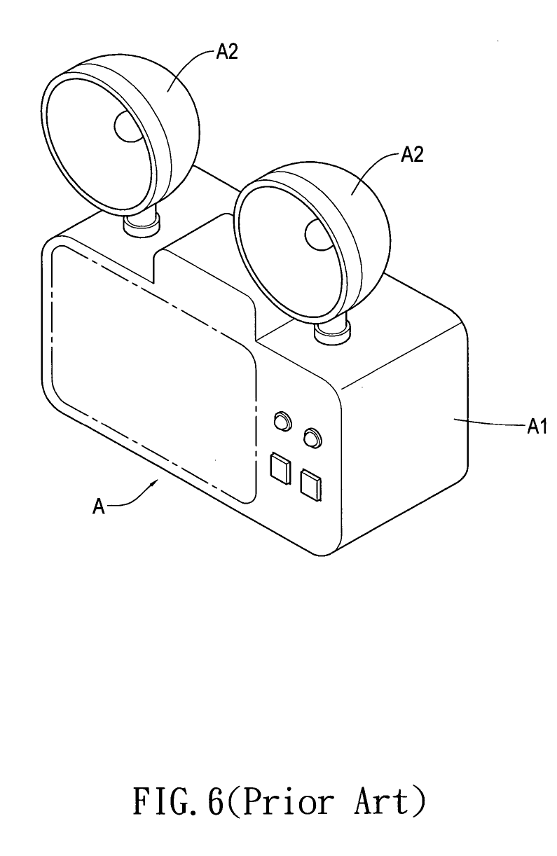

### DETAILED DESCRIPTION OF THE PREFERRED EMBODIMENT

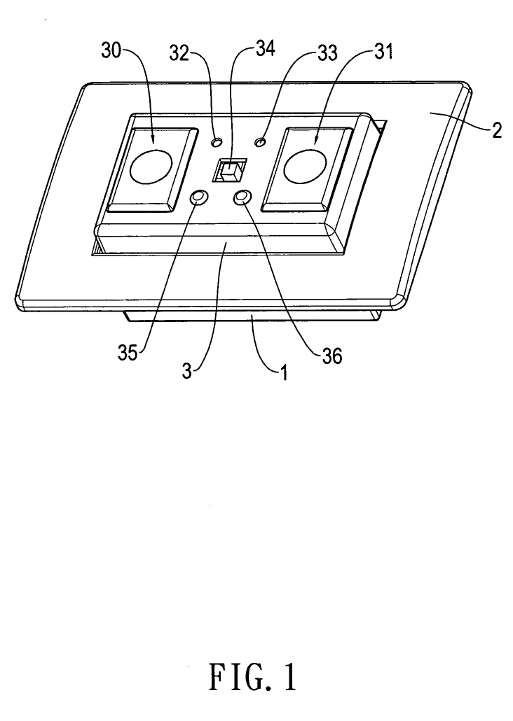

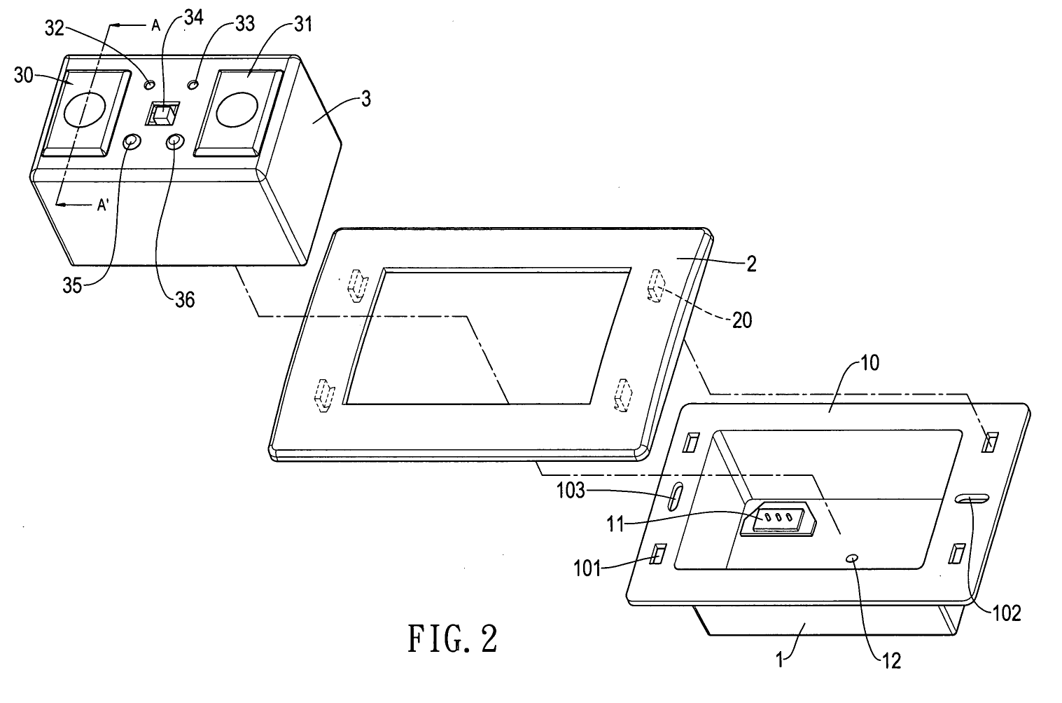

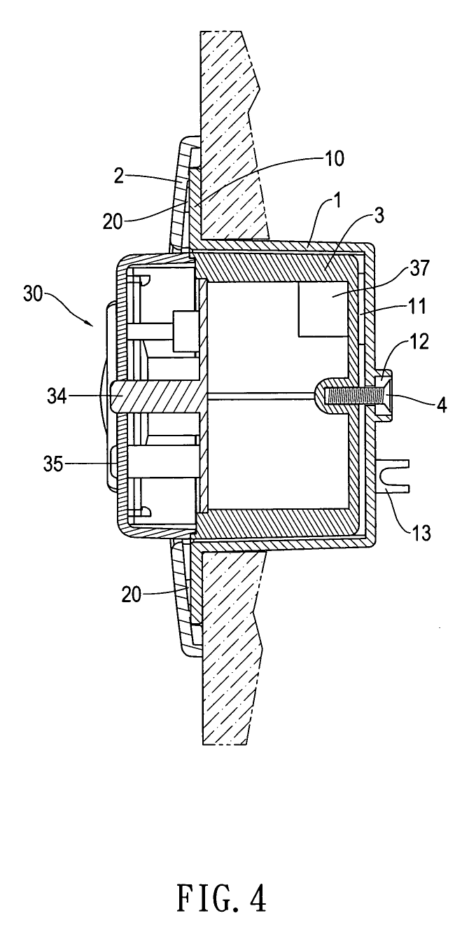

Referring to FIGS. 1 and 2 simultaneously, an emergency luminaire of the present invention comprises a lower housing 1, an upper frame 2 and a lighting apparatus 3. The lower housing 1 has an opening surrounding by a horizontal extension plate 10 on which several through holes 101, a transversal fine-tuning/fixing hole 102 and a longitudinal fine-tuning/fixing hole 103 are formed. In addition, a charging socket 11 and a coupling fixing hole 12 are located on the inside of the lower housing 1. A screw holder 13 (shown in FIG. 4) is mounted on the outside bottom of the lower housing 1 for holding a screw 4.

The upper frame 2 is designed to be attached to the extension plate 10 that surrounds the opening of the lower housing 1. Several hooks 20 are mounted on the backside of the upper frame 2 at positions corresponding to the through holes 101 of the extension plate 10. Besides, the color of the upper frame 2 can be changed at will.

The lighting apparatus 3 is designed to be mounted on the inside of the lower housing 1. The lighting device 3 has two light-emitting devices and a control means on the front surface. As exemplified in the present preferred embodiment, the light-emitting devices are two light-emitting diodes 30 and 31. The control means is mounted between the light-emitting diodes 30 and 31, and comprises a power-status indicator light 32, a charge-status indicator light 33, a test button 34, and two control switches 35 and 36 for switching on or off the light-emitting diodes 30 and 31. The lighting apparatus 3 has a charging plug 37 (shown in FIG. 4) and a coupling fixing hole 38 on the backside. In addition, the lighting apparatus 3 has a control circuit and a battery on the inside.

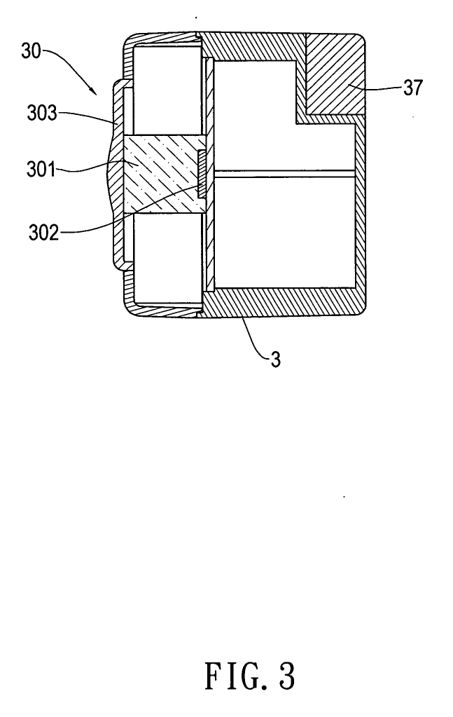

Referring to FIG. 3, the light-emitting diode 30 is principally comprised of a fluorescent colored light-guiding pillar 301 embedded in front of a light-emitting chip 302 and a fluorescent colored transparent convex plate 303 attached to the top of the light-guiding pillar 301 in such a way that the light emitted from the light-emitting chip 302 can be outputted to the outside via the light-guiding pillar 301 so as to increase the intensity of light. Moreover, the color of the light-guiding pillar 301 can be changed at will.

If it is desired to apply the emergency luminaire to a public location such as a hotel, the lighting apparatus 3 is first mounted into the lower housing 1 to couple the charging plug 37 with the charging socket 11 and to align the coupling fixing holes 38 and 12 to each other. Next, the screw 4 is detached from the screw holder 13, and applied to screw the lighting apparatus 3 and the lower housing 1 together in such a way that the lighting apparatus 3 cannot be pulled out easily. Referring to FIGS. 2 and 4 simultaneously, the lower housing 1 can be coupled with a switch box, which is previously embedded in the interior of the hotel, via the transversal fine-tuning/fixing hole 102 and the longitudinal fine-tuning/fixing hole 103. An electric cord of the charging socket 11 is electrically connected to the commercial electric power. Next, the upper frame 2 is coupled with the lower housing 1 by hooking the hooks 20 into the through holes 101 of the extension plate 10 so as to provide the lower housing 1 with a neat and tidy appearance and to thus complete the assembly.

In a normal condition, the battery inside the lighting apparatus 3 can store the commercial electric power via the charging plug 37 and the charging socket 11. At this moment, the power-status indicator light 32 and the charge-status indicator light 33 will be turned on to notify the user that the emergency luminaire is in the charge status. In addition, the light-emitting diodes 30 and 31 can be checked to see whether they are out of order by pressing the test button 34. If the commercial electric power is disconnected, the control circuit inside the lighting device 3 can turn on the light-emitting diodes 30 and 31. At this moment, the power-status indicator light 32 should be turned off to indicate that the commercial electric power is disconnected, and the battery can supply the electric power stored therein for the light-emitting diodes 30 and 31 for lighting up the interior space. Moreover, the lighting device 3 is protected from loss since it is assembled to the lower housing 1 tightly.

Referring to FIG. 4, if it is desired to apply the emergency luminaire to a private location such as a general dwelling house, the upper frame 2 is first coupled with the lower housing 1 by hooking the hooks 20 into the through holes 101 of the extension plate 10 so as to provide the lower housing 1 with a neat and tidy appearance. Next, the lower housing 1 is attached to a proper interior position, and the charging socket 11 is electrically connected to the commercial electric power. Next, the lighting apparatus 3 is inserted into the lower housing 1 directly so as to insert the charging plug 37 into the charging socket 11 in such a way that the battery inside the lighting apparatus 3 can store the commercial electric power via the charging plug 37 and the charging socket 11. If the commercial electric power is disconnected suddenly, the control circuit inside the lighting device 3 can turn on the light-emitting diodes 30 and 31. At this moment, the power-status indicator light 32 is turned off, and the battery can supply the electric power stored therein for the light-emitting diodes 30 and 31 for lighting up the interior space. When the user wants to move to other location, he/she can detach the lighting device 3 from the lower housing 1 directly. As a result, the lighting device 3 becomes a portable flashlight.

The structure of the emergency luminaire of the present invention is in compliance with all fire fighting specifications and emergency illumination standards such as CNS8802C4348. The emergency luminaire is made of a heat-resistant and fire-resistant ABS material. Furthermore, the intensity of light is larger than 10 Lux, and it is not easy to turn off the light since the light should be always turned on when in emergency. In addition, the duration of illumination is larger than 1.5 hours.

From the above description, it can be seen that the present invention has the following advantages:

1. The emergency luminaire of the present invention has so simplified components that its size and weight can be reduced efficiently. The lighting apparatus of the present invention can be embedded into the general indoor switch box. The color of the lighting apparatus is designed to match that of the interior space so it is pleasing to the eye and not an eyesore as the conventional emergency luminaire.

2. If the emergency luminaire of the present invention is applied to the public location, the lighting apparatus can be coupled with the lower housing by the screw to protect itself from being stolen for preventing the function of emergency illumination from loss.

3. If the emergency luminaire of the present invention is applied to the private location, the lighting apparatus can be inserted into the lower housing directly. When an emergency condition occurs, the lighting apparatus can provide the function of emergency illumination and can be detached from the lower housing to become a portable emergency flashlight.

In summary, the present invention indeed achieves the anticipated objects by disclosing an improved emergency luminaire. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An emergency luminaire comprising:
a lower housing having a charging socket mounted therein;
an upper frame detachably attached to said lower housing; and
a lighting apparatus having a charging plug in the backside thereof corresponding to said charging socket and two light-emitting devices and a control means on the front thereof, wherein said lower housing is first attached to a proper indoor location to allow said charging socket to electrically connect with the commercial electric power, and said lighting apparatus is then inserted into said lower housing to insert said charging plug into said charging socket so as to allow a battery mounted inside said lighting apparatus to store said commercial electric power, whereby when said commercial electric power is disconnected suddenly, said battery can supply electric power stored therein for illumination and said lighting apparatus is detachable from said lower housing for providing portable illumination for user.

2. An emergency luminaire of claim 1, wherein said lower housing has an opening surrounding by a horizontal extension plate on which a plurality of through holes are formed.

3. An emergency luminaire of claim 2, wherein said upper frame is designed to be attached to said horizontal extension plate of said lower housing, and said upper frame has a plurality of hooks on the backside thereof for hooking said through holes formed on said horizontal extension plate of said lower housing.

4. An emergency luminaire of claim 2, wherein said through holes comprise a transversal fine-tuning/fixing hole and a longitudinal fine-tuning/fixing hole.

5. An emergency luminaire of claim 1, wherein said two light-emitting devices on said front of said lighting apparatus are two light-emitting diodes.

6. An emergency luminaire of claim 5, wherein each of said two light-emitting devices has a chip and a fluorescent colored light-guiding pillar and a fluorescent colored transparent convex plate in front of said chip to enhance intensity of light.

7. An emergency luminaire of claim 6, wherein said fluorescent colored light-guiding pillar and said fluorescent colored transparent convex plate have freely changeable colors.

8. An emergency luminaire of claim 1, wherein said lower housing has a screw holder on the bottom backside thereof for holding a screw.

9. An emergency luminaire of claim 1, wherein said lower housing and said lighting apparatus have respective coupling fixing holes for screwing thereinto of a screw to prevent said lighting apparatus and said lower housing from separation.

10. An emergency luminaire of claim 1, wherein said control means of said lighting apparatus comprises two indicator lights, a test button, and two control switches for controlling said two light-emitting diodes.
